(19) United States
(12) Patent Application Publication
(10) Pub. No.: US 2014/0330615 A1
(43) Pub. Date: Nov. 6, 2014

(54) RISK ESTIMATION OF INSPECTION SITES

(71) Applicant: ORACLE INTERNATIONAL CORPORATION, Redwood Shores, CA (US)

(72) Inventors: William H. DUMOUCHEL, Tucson, AZ (US); Robert WEBER, Berlin (DE)

(73) Assignee: ORACLE INTERNATIONAL CORPORATION, Redwood Shores, CA (US)

(21) Appl. No.: 13/886,719

(22) Filed: May 3, 2013

(51) Int. Cl. G06Q 10/06

(52) U.S. Cl. CPC G06Q 10/0635
USPC 705/7.28

(57) ABSTRACT

A system for estimating a risk that a site will have deficiencies receives data relating to the site. The data comprises a plurality of previous inspection results of the site. The system determines a risk score that corresponds to the expected deficiencies that would be found if the site were inspected, where a poor risk score corresponds to a higher risk of having deficiencies. The risk score for the site is based upon the plurality of previous inspection results of the site, and previous deficiencies worsen the determined risk score for the site.

### FIELD

One embodiment is directed generally to a computer system, and in particular to a computer system that estimates risk for inspection sites.

### BACKGROUND INFORMATION

An inspection (also referred to as an audit, depending on the industry and the inspecting organization) is generally understood as an organized examination or evaluation conducted at a site. An inspection of a site may involve the review of documents, the review of quality records, the conducting of various tests, and/or the taking of various measurements at the site. An inspection may be conducted to ensure that a site complies with established regulations and/or standards. An inspection may be conducted at a site to regulate the quality of goods produced or services performed at the site, to ensure that proper manufacturing methods are performed at the site, to ensure that contaminants are properly controlled at the site, to ensure that safe working conditions exist at the site, or to ensure that waste materials are properly disposed of at the site, for example. Data that is collected during the course of an inspection may be analyzed with respect to the types of activities occurring at the site.

For example, an inspecting entity may inspect a manufacturing site by collecting information relating to the site. The inspecting entity may collect information derived from records present at the manufacturing site, examine the facilities of the manufacturing site, and examine any other assets at the manufacturing site that are deemed to be relevant to the inspection. The inspecting entity may then determine if the manufacturing site is in compliance with established regulations. After the inspection is completed, the inspecting entity may conduct future inspections as needed based upon the results of the completed inspection.

When a site fails to meet the regulations and/or standards that pertain to an inspection, the site may be described as “failing inspection.” When a site fails inspection, the inspection typically describes specific deficiencies that contributed to the site failing inspection. These deficiencies may be referred to as the “findings” of the inspection.

### SUMMARY

One embodiment is a system for estimating a risk that a site will have deficiencies. The system receives data relating to the site. The data comprises a plurality of previous inspection results of the site. The system determines a risk score that corresponds to the expected deficiencies that would be found if the site were inspected, where a poor risk score corresponds to a higher risk of having deficiencies. The risk score for the site is based upon the plurality of previous inspection results of the site, and previous deficiencies worsen the determined risk score for the site.

### BRIEF DESCRIPTION OF THE DRAWINGS

FIG. 1 is an overview block diagram of a computer system for estimating risk for at least one site in accordance with an embodiment of the present invention.

FIG. 2 is a screenshot of an interface that allows a user to examine risk scores for different sites, in accordance with one embodiment.

FIG. 3 is a screenshot of an interface that shows information relating to the risk scores of a group of sites that is managed by a same company group, in accordance with one embodiment.

FIG. 4 is a flow diagram of the functionality of the estimating risk module of FIG. 1 in accordance with one embodiment.

### DETAILED DESCRIPTION

One embodiment estimates the risk that sites will have deficiencies by determining risk scores for the sites. The risk scores correspond to the expected deficiencies that would result if the sites were inspected. One embodiment determines the risk scores by using a systematic analysis of data. Once risk scores are determined for the sites, inspections of the sites can be scheduled in accordance with the determined risk scores.

In general, known inspection systems schedule inspections by listing the sites to be inspected, sequentially inspecting each listed site from a first site to a last site, and then conducting subsequent rounds of inspection by beginning examination again starting from the first site and ending at the last site. The previous approaches generally did not schedule inspections for sites based on any determined risk score that corresponds to expected deficiencies that would result. At most, the previous approaches would schedule inspections for sites based on historic estimates of risk at the time of the previous inspections, as opposed to using any systematic analysis of data. For example, the previous approaches generally would, at most, estimate the risk that a specific site will fail an inspection based upon an immediately preceding inspection result for the specific site. In other words, a specific site may be deemed to have higher risk of failing inspection if the site failed the immediately preceding inspection.

In contrast to the previous approaches, one embodiment of the present invention estimates a risk for at least one site that the site will have deficiencies. One embodiment estimates the risk for the site by determining a risk score that corresponds to the expected deficiencies that would result, and determines the risk score using a systematic analysis of data that is available at the current point in time. For example, as described in more detail below, embodiments of the present invention determine a risk score by examining: (1) a plurality of previous inspection results of a specific site, (2) site self-assessment results and other information collected about the site or its company, (3) the amount of time that has elapsed since previous inspections, (4) potential correlations of risk that may exist among sites that are governed by the same management as the specific site, and (5) a totality of risk information for companies and sites for the respective industry or regulated area in the inspection program.

In one embodiment, the risk score may be determined based upon a constructed mathematical/statistical model that receives the various data inputs. This risk score may then be delivered to the user.

In one embodiment, the system can deliver a large ensemble of risk scores, which can vary according to the estimated risk at different times, for the various inspection sites of a given company, and for various groups of companies that may have mutual ownership or other relationships. These risk scores may depend on an analysis of a large database of previously date-stamped inspection scores (that may be assigned to inspected sites by inspectors) and other information about sites and/or companies that is deemed relevant to the probability of finding deficiencies during subsequent inspections. These data and predictions may be integrated into an Empirical Bayes State Space Model that assumes certain probabilistic relationships among the data.

This model may assume that there is an inherent risk level for every site that changes over time, where time may be discretized at the level of months, or quarters, or some other frequency, depending on the specific application. For example, the data being analyzed may relate to 500 companies (C=500 companies), and a specific company (Company “i”) may have a 10 sites (Sᵢ=10 sites). Other companies may have a number of sites ranging from 1 to hundreds of sites. The data collection and desired risk estimates may extend in time over a span of time, such as 20 quarters (0=20 quarters), for example. Other embodiments may use increments of time that are different than quarters. Xᵢₛₚ may represent an inspection score collected during quarter “q” at site “s” of company “i.” Although there may only be inspection scores collected for a few thousand out of a hundred thousand or more potential combinations of companies, sites, and quarters (i,s,q), in one embodiment, the statistical model may assume the existence of an inherent expected risk present in all such combinations, and may represent the logarithm of such an inherent expected risk as θ_{isq}, and may further assume certain probabilistic properties relating to these unknown quantities.

In particular, in one embodiment, the state space model may assume a multivariate prior distribution for all of the values of θ_{isq}, and this prior distribution may depend on certain other values, called hyper-parameters, that can be estimated using empirical Bayes methodology. An example set of assumptions to define such a multivariate prior distribution is as follows:

θ_{isq}˜N(μᵢ,σ²);i=1, . . . ,C;s=1, . . . ,Sᵢ;q=1, . . . ,Q (1)

corr(θᵢₛₚ,θ_{itq})=ρ;i=1, . . . ,C;s,t=1, . . . Sᵢ,s≠t;q=1, . . . ,Q (2)

corr(θ_{isq},θ_{is(q+1)})=τ;i=1, . . . ,C;s=1, . . . Sᵢ;q=1, . . . ,Q (3)

These assumptions state that each inherent log-risk (each inherent risk as represented by logarithms) has a normal prior distribution (with standard deviation a) and mean that depends on the company, and that the prior correlation between the inherent log-risk of any two sites of the same company at the same time is ρ, and that the prior correlation of the inherent log-risk of the same site across two adjacent quarters is τ. Three hyper-parameters (σ, ρ, τ) determine the assumed prior probabilistic relationships among the inherent risks and must be estimated from the data across all companies, whereas, once estimates of the hyper-parameters are obtained, the estimates of the θ_{isq} can be obtained using calculations and data restricted to one company I at a time. As such, one embodiment is directed to separation of the calculations into a first stage to estimate the hyper-parameters and a second stage allowing separate calculations for each company.

In one embodiment, a statistical model describes the relationship between the inherent but unobserved risk parameters θ_{isq}, the observed inspection data X, and other company and site-specific observed data, possibly denoted Y. For example, a risk score X_{isq} may be assumed to have a negative binomial distribution with a mean exp(θ_{isq}). The auxiliary data Y may be of K different types, but restricted to consist of the presence or absence of a particular event at a particular time relating to a particular company and site. Thus Y_{isqk} is observed to be either 0 or 1 depending on whether event type k was observed at site s of company i during quarter q. The probability that Y_{isqk}=1 may be assumed to satisfy:

P(Y_{isqk}=1)=1/[1+exp(aₖ−bₖθ_{isq})];i=1, . . . ,C;s=1, . . . ,Sᵢ;q=1, . . . ,Q;k=1, . . . ,K

This equation describes a logistic regression relationship between the events defined by the Y's and the inherent risk parameters, defined by the corresponding θ_{isq}. The logistic coefficients aₖ and bₖ also can be estimated from the available data.

One embodiment of the present invention uses maximum posterior density estimation techniques based on the foregoing probabilistic formulation, and related techniques, to produce estimates and confidence intervals for expected risk scores for every company, site, and time period. These estimates are used to give greater priority for future inspections to sites that are determined to be at high risk for poor risk scores.

In one embodiment, once risk scores are calculated for a plurality of sites, a system may plan future inspections according to the calculated risk scores. As time passes, the risk scores associated with the plurality of sites may be re-computed/updated as needed. One embodiment may provide a user with the ability to re-compute risk scores on either an automatically scheduled or an ad-hoc basis.

In the course of conducting inspections, an inspecting entity (e.g., a government agency or a commercial enterprise) may have to conduct effective inspections using limited resources. For example, an inspecting entity may need to inspect a multitude of inspection sites with only a few inspection personnel. Given the need to conduct effective inspections using these limited resources, the inspecting entity may need to determine how to effectively allocate the limited resources. For example, the inspecting entity may need to decide how often each site is inspected and which sites should be inspected multiple times. As such, large commercial enterprises and government agencies alike would benefit from a comprehensive tool that both: (1) handles the management of the inspection of sites and (2) implements risk-estimation algorithms to determine risk scores for the sites.

In view of the above, one embodiment schedules inspections for sites by allocating limited inspection resources based on determined risk scores that correspond to expected deficiencies for the sites. One embodiment may schedule earlier inspections for sites which have poor risk scores (sites which have higher estimated levels of risk of having deficiencies). In one embodiment, a numerically high risk score can correspond to a poor risk score (the higher the numerical risk score, the greater the risk of finding deficiencies). However, other embodiments may instead designate numerically low risk scores to correspond to poor risk scores instead. One embodiment may allocate more resources to sites which have poorer risk scores. For example, multiple inspections may be scheduled for sites with poorer risk scores.

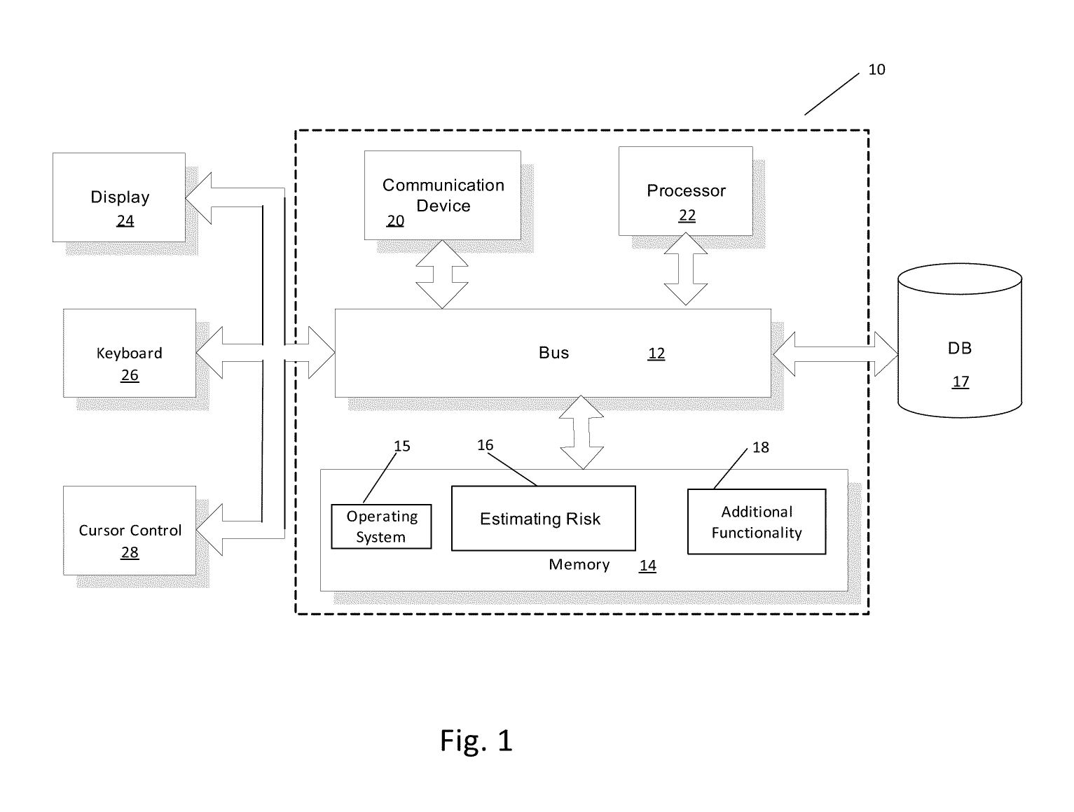

FIG. 1 is an overview block diagram of a computer system 10 for estimating risk for at least one site in accordance with an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other known method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 may be further coupled via bus 12 to a display 24, such as a Liquid Crystal Display (“LCD”). A keyboard 26 and a cursor control device 28, such as a computer mouse, may be further coupled to bus 12 to enable a user to interface with system 10.

In one embodiment, memory 14 stores software modules that provide functionality when executed by processor 22. The modules include an operating system 15 that provides operating system functionality for system 10. The modules further include estimating risk module 16 for estimating a risk for at least one site that the site will have deficiencies, as disclosed in more detail below. System 10 can be part of a larger system such as a pharmacovigilance system using Oracle Health Sciences Pharmacovigilance Suite™ provided by Oracle Corp. Therefore, system 10 will typically include one or more additional functional modules 18 to include additional functionality, such as data processing functionality for conducting systematic analysis of data that is used to estimate levels of risk of various sites. A database 17 is coupled to bus 12 to store data used with modules 16 and 18.

In one embodiment, the estimated level of risk of a site may be based upon a plurality of previous inspection results of the site. For example, the estimated level of risk for a site may be higher if the previous inspection results of the site were poor. A site with a history of failed inspections may have a higher estimated level of risk. Further, in some embodiments, risk estimates are not only based on past inspection results for the same site, but also on results from other sites of the same company.

Further, the estimated level of risk for a site may depend on the severity of the specific findings of each of the previous inspections. In one embodiment, the findings of an inspection may be categorized in terms of how severe the findings are. For example, a finding may be considered as: (1) a “minor” finding, (2) a “major” finding, or (3) a “critical” finding. A minor finding may be considered to be a negative finding that may be readily fixed, or that is relatively unimportant. A major finding may be considered to be a negative finding that may not be readily fixed, and that may be relatively important. A critical finding may be considered to be a negative finding that has the most severe negative effect on a site's inspection performance and is severely important to remedy.

The risk score will reflect a higher risk of having deficiencies if the previous inspections discovered negative findings of greater severity. Each of the previous inspections may also have an associated negative score that reflects the severity of the findings of the previous inspections. Each type of negative finding of a previous inspection may be weighted differently (with “minor” findings having the lowest weight and “critical” findings having the heaviest weight) to determine an overall negative score for an inspection. The risk score of the site may be based upon this negative score.

For example, a negative score for a specific inspection may be determined based upon equation (1) below:

Negative score=(A×N_{Minor})+(B×N_{Major})+(C×N_{Critical}) (4)

Coefficient “A” corresponds to the weight for minor findings. Coefficient “B” corresponds to the weight for major findings. Coefficient “C” corresponds to the weight for critical findings. N_{Minor} corresponds to the number of minor findings discovered in the course of the specific inspection. N_{Major} corresponds to the number of major findings discovered in the course of the specific inspection. N_{critical} corresponds to the number of critical findings discovered in the course of the specific inspection.

One embodiment may also determine an estimated risk of a site based upon an amount of time that has elapsed since deficiencies were previously found. For example, sites which were recently determined to have deficiencies may be more prone to having future deficiencies as compared to sites which had deficiencies a long time ago. For example, if a site uses poor practices in January and fails inspection in January, the site may also be likely to use poor practices in the following month of February. As such, in one embodiment, the estimated risk of a site depends on the amount of time that has elapsed since discovering past deficiencies. In estimating the risk of a site according to such criteria, in one embodiment, the more recent the determined deficiencies, the poorer the risk scorer for the site (e.g., the higher the risk score).

In addition to determining a risk score for a specific site based upon the previous inspection results of the specific site, another embodiment may estimate risk for the specific site based upon previous inspections of other inspected sites related to the specific site. For example, one embodiment may determine a risk score for a specific site based upon the previous inspection results of other inspected sites that are under a same management as the specific site.

When any given site is discovered to have deficiencies, the deficiencies may be a result of poor management of the given site by a managing entity. If this managing entity manages multiple sites, the other managed sites may also suffer from the same deficiencies (due to poor practices systemic to the managing entity, for example). As such, one embodiment will adjust the determined risk score of a specific site based upon the performance of other sites under the same management as the specific site. For example, suppose that a first site and a second site are under the same management. Further, suppose that the first site is discovered to have deficiencies. One embodiment would then worsen (e.g., increase) the determined risk score of the second site based upon the deficiencies of the first site, even though the second site has not been inspected yet. By increasing the estimated risk of the second site, as previously discussed, one embodiment may then schedule an earlier inspection for the second site.

In addition to modifying a determined risk score of a specific site based upon the performance of other sites under the same management as the specific site, other embodiments may examine the performance of other sites that are not under the same management, yet are somehow related to the specific site. The embodiment may conduct statistical analysis on a plurality of inspections results to determine correlations that may exist between the inspection results of the specific site and the inspection results of other sites.

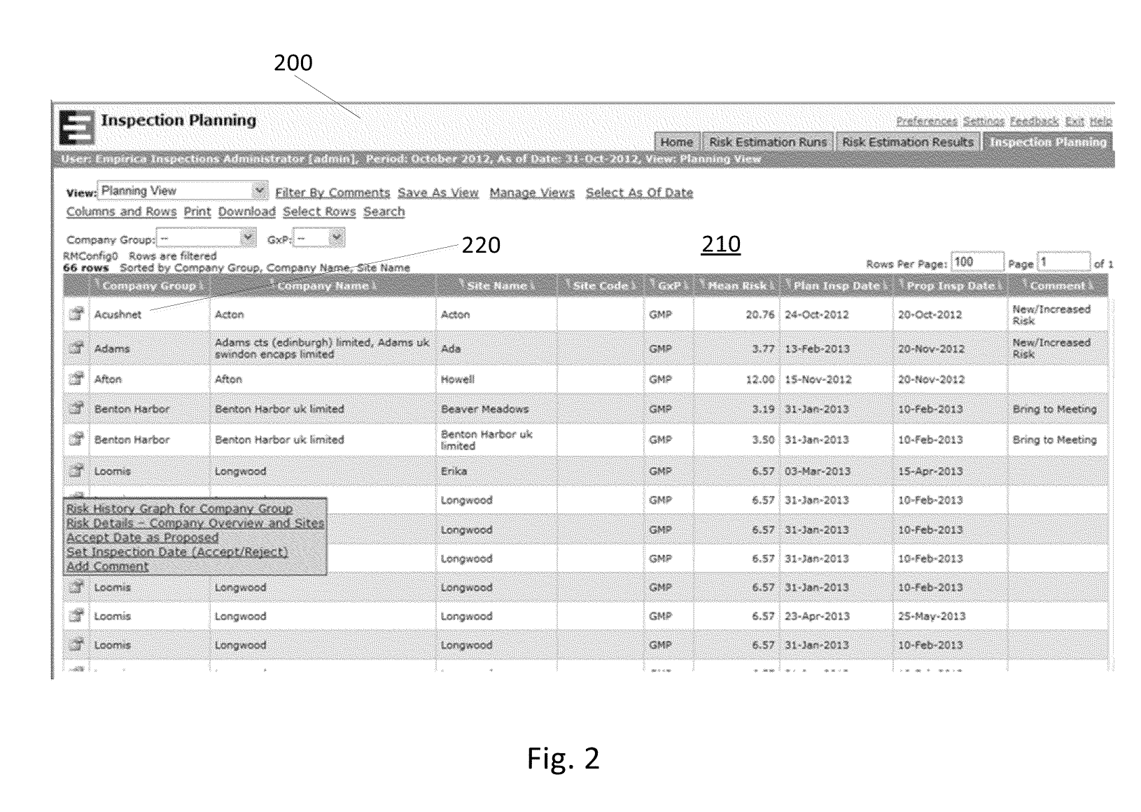

FIG. 2 is a screenshot of an interface 200 that allows a user to examine risk scores 210 for different sites, in accordance with one embodiment. As shown in FIG. 2, each site can have an associated “company group,” “company name,” “site name,” and “mean risk.” For example, site 220 is associated with “Acushnet” company group, is associated with “Acton” company name, has “Acton” as a site name, and has a mean risk (risk score) of “20.76.” As can be seen in FIG. 2, a plurality of different sites can be shown.

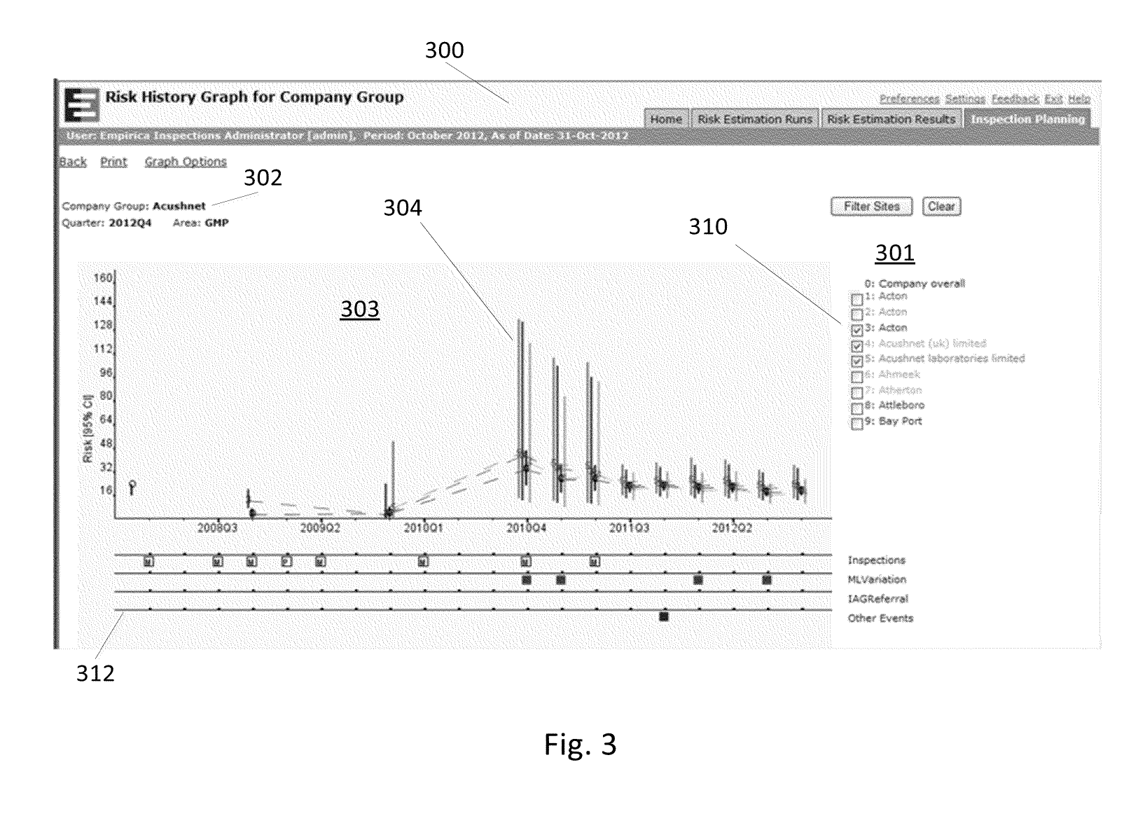

FIG. 3 is a screenshot of an interface 300 that shows information relating to the risk scores of a group of sites 301 that is managed by a same company group 302, in accordance with one embodiment. As shown in FIG. 3, a group of sites 301 includes “Acton (S86805-7779),” “Acushnet (uk) limited (S13042-7779),” and “Acushnet laboratories limited (S8067-7779),” for example. The sites shown in the group of sites 301 can all be associated with a single company group 302 named “Acushnet,” for example. In the example shown in FIG. 3, each of these three sites has been selected, using checkboxes 310, to be shown on chart 303. Chart 303 shows a plurality of lines 304 for each time period of chart 303. Each line of the plurality of lines 304 corresponds to a selected site from the group of sites 301. As such, by examining chart 303, a user can see the risk scores for a plurality of sites (which may belong to a company group) over different periods of time.

FIG. 3 further shows a “risk time trend” for selected sites from the company group “Acushnet.” Each vertical bar 304 depicts the risk score for one site at a particular point in time, with numbers/colors indicating the respective site from the legend 310 on the right. The upper and lower end of the bars 304 mark the upper and lower end of the 90% confidence interval for the risk estimate, and the point where the horizontal line crosses the vertical bar (also marked with the legend number) indicates the mean risk estimate.

The “tram lines” 312 underneath the trend graph show the presence of inspections and individual risk events (event type indicated in the legend on the right) for the company group “Acushnet” at particular points in time. By clicking on the symbols in the tram line, a user can drill down to further risk event details.

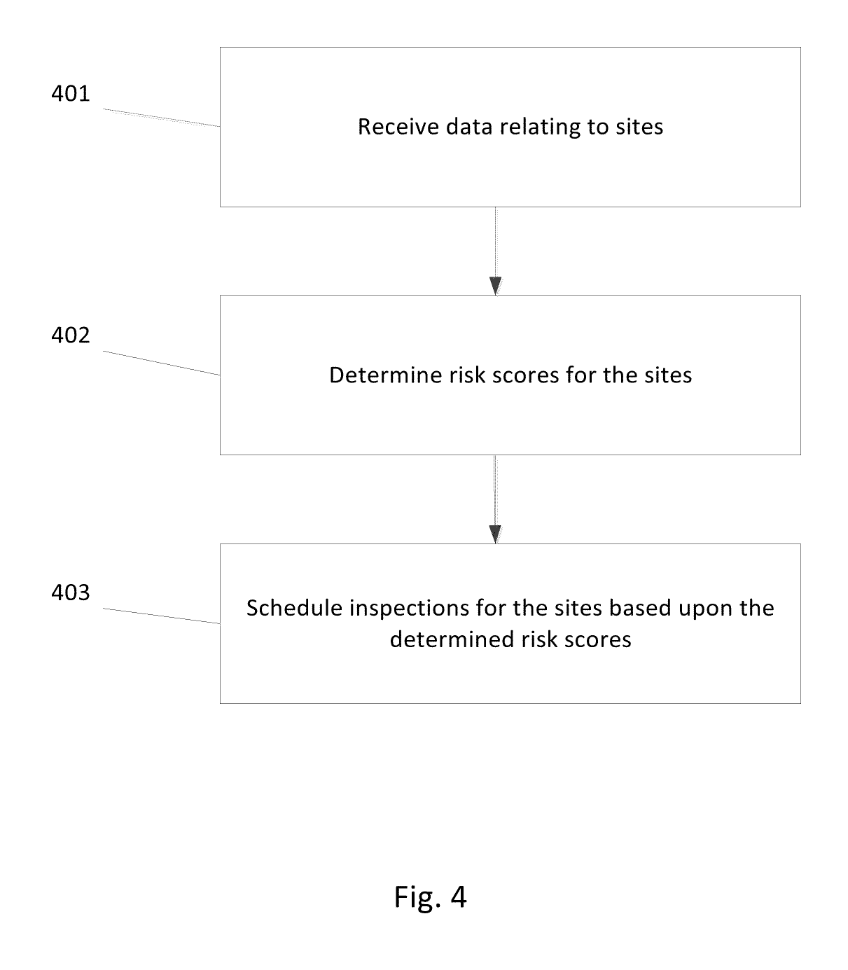

FIG. 4 is a screenshot of an interface 400 that shows information relating to risk scores according to site 410, according to company 430, and according to company group 420, in accordance with one embodiment. For example, in the example shown in interface 400, information relating to risk scores according to site 410 shows two “findings” 412 for a particular site which occurred on “Jan. 21, 2010.”

Additionally, one embodiment may also determine a risk score for a site based upon external data that has not been gathered via any inspection. Such data may be generally referred to as external non-inspection data. One example of external non-inspection data of a site is data relating to the financial health of a company operating the site. The financial health of the company operating at the site may be relevant to the risk that the site will have deficiencies. For example, if a company is under financial pressure, the company may begin to use poor management practices to save money. These poor management practices may then result in a higher risk of having deficiencies by the sites of the company.

As such, one embodiment may collect and analyze financial data of a company and adjust the determined risk score of sites managed by the company accordingly. For example, if the financial data of a company suggests that the company is having financial difficulties, one embodiment may determine that the sites of the company should have higher estimated risk as compared to when the company does not have financial difficulties.

Although data relating to the financial health of a company may be one example of external non-inspections data used to determine an determined risk score for a site, many other types of external non-inspections data exist. As another example, one embodiment may estimate risk of a site based upon information provided by whistleblowers against a company. As another example, one embodiment may estimate risk of a site based upon information transferred from other government agencies (e.g., the U.S. Food and Drug Administration (“FDA”)). These events are codified, using the data notation described above, so that for a particular k, Y_{isqk}=1 if, for example, a whistle-blower report relating to site s of company i is received during quarter q, whereas a different value of k would be used to record the existence of relevant information from the FDA.

As another example of using non-inspections data to determine an estimated risk for a site, one embodiment may use information derived from documents produced during the course of an internal audit of a company. For example, in addition to being inspected by the FDA, a pharmaceutical company will generally have its own pharmacovigilance (“PV”) team to conduct internal audits. One embodiment may base the risk score on information produced during the course of an internal audit by these PV teams.

FIG. 4 is a flow diagram of the functionality of the estimating risk module 16 of FIG. 1 in accordance with one embodiment. In one embodiment, the functionality of the flow diagram of FIG. 4 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 401, one embodiment receives data relating to sites. As discussed above, the data may include a plurality of previous inspection results of the sites. As discussed above, the data may also include data relating to the financial health of the companies that operate the sites.

At 402, one embodiment determines a risk score for at least one site that corresponds to the expected deficiencies that would be found if the site were inspected. A higher risk score can correspond to a higher risk of having deficiencies. As discussed above, the determined risk scores for the sites may be based upon a plurality of previous inspection results of the sites. Previous deficiencies tend to worsen the determined risk score for the site. As discussed above, the estimated level of risk that a specific site will have deficiencies may also be based upon previous inspection results of other sites that are under a same management as the specific site. As discussed above, the estimated levels of risk for the sites may also be based upon the financial health of the companies that operate the sites, and poor financial health of the companies tends to increase the estimated levels of risk for the sites.

At 403, one embodiment schedules inspections for the sites based upon the determined risk scores. Sites that have higher estimated levels of risk may be scheduled before sites with lower estimated levels of risk.

As described above, one embodiment of the present invention determines risk scores that correspond to the levels of risk that sites will have deficiencies using a systematic analysis of data. For example, as discussed above, embodiments of the present invention estimate the risk that a specific site will have deficiencies by examining: (1) a plurality of previous inspection results of the specific site, (2) an amount of time that has elapsed since a previous deficiency was discovered, (3) external non-inspection data relating to the specific site, and (4) potential correlation of risk that may exist among sites that are governed by the same management as the specific site.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, causes the processor to estimate a risk for at least one site that the at least one site will have deficiencies, the estimating comprising:
receiving data relating to the at least one site, wherein the data comprises a plurality of previous inspection results of the at least one site; and
determining a risk score that corresponds to the expected deficiencies that would be found if the at least one site were inspected, wherein a poor risk score corresponds to a higher risk of having deficiencies, the risk score for the at least one site is based upon the plurality of previous inspection results of the at least one site, and previous deficiencies worsen the determined risk score for the at least one site.

2. The computer readable medium of claim 1, wherein the determining the risk score is also based upon previous inspection results of other sites that are under a same management as the at least one site.

3. The computer readable medium of claim 1, wherein the received data relating to the at least one site also comprises data relating to the financial health of a company that operates the at least one site, and the determined risk score for the at least one site is also based upon the financial health of the company that operates the at least one site, and poor financial health of the company worsens the determined risk score for the at least one site.

4. The computer readable medium of claim 1, wherein the received data relating to the at least one site also comprises data relating to negative findings produced during the previous inspections of the at least one site, and having negative findings of greater severity worsens the determined risk score for the at least one site.

5. The computer readable medium of claim 1, wherein the risk score for the at least one site is based upon an amount of time that has elapsed since deficiencies were last found.

6. The computer readable medium of claim 1, wherein the risk score for the at least one site is automatically recalculated according to a schedule.

7. A method for estimating a risk for at least one site that the at least one site will have deficiencies, the method comprising:
receiving data relating to the at least one site, wherein the data comprises a plurality of previous inspection results of the at least one site; and
determining a risk score that corresponds to the expected deficiencies that would be found if the at least one site were inspected, wherein a poor risk score corresponds to a higher risk of having deficiencies, the risk score for the at least one site is based upon the plurality of previous inspection results of the at least one site, and previous deficiencies worsen the determined risk score for the at least one site.

8. The method of claim 7, wherein the determining the risk score is also based upon previous inspection results of other sites that are under a same management as the at least one site.

9. The method of claim 7, wherein the received data relating to the at least one site also comprises data relating to the financial health of a company that operates the at least one site, and the determined risk score for the at least one site is also based upon the financial health of the company that operates the at least one site, and poor financial health of the company worsens the determined risk score for the at least one site.

10. The method of claim 7, wherein the received data relating to the at least one site also comprises data relating to negative findings produced during the previous inspections of the at least one site, and having negative findings of greater severity worsens the determined risk score for the at least one site.

11. The method of claim 7, wherein the determined risk score for the at least one site is based upon an amount of time that has elapsed since deficiencies were last found.

12. The method of claim 7, wherein the risk score for the at least one site is automatically recalculated according to a schedule.

13. A system for estimating a risk for at least one site that the at least one site will have deficiencies, the system comprising:
a processor;
a memory coupled to the processor;
a receiving module that receives data relating to the at least one site, wherein the data comprises a plurality of previous inspection results of the at least one site; and
an determining module that determines a risk score that corresponds to the expected deficiencies that would be found if the at least one site were inspected, wherein a poor risk score corresponds to a higher risk of having deficiencies, the risk score for the at least one site is based upon the plurality of previous inspection results of the at least one site, and previous deficiencies worsen the determined risk score for the at least site.

14. The system of claim 13, wherein the determining the risk score is based upon previous inspection results of other sites that are under a same management as the at least one site.

15. The system of claim 13, wherein the received data relating to the at least one site also comprises data relating to the financial health of a company that operates the at least one site, and the determined risk score for the at least one site is also based upon the financial health of the company that operates the at least one site, and poor financial health of the company worsens the determined risk score for the at least one site.

16. The system of claim 13, wherein the received data relating to the at least one site also comprises data relating to negative findings produced during the previous inspections of the at least one site, and having negative findings of greater severity increases the determined risk score for the at least one site.

17. The system of claim 13, wherein the risk score for the at least one site is based upon an amount of time that has elapsed since deficiencies were last found.

18. The system of claim 13, wherein the risk score for the at least one site is automatically recalculated according to a schedule.
